(19) United States
(12) Patent Application Publication
(10) Pub. No.: US 2007/0148460 A1
(43) Pub. Date: Jun. 28, 2007

(54) Pigments sheathed with polyaddition products, method for their produciton and use thereof

(75) Inventors: Ulrike Licht, Mannheim (DE); Christian Kruger, Saulheim (DE); Markus Antonietti, Bergholz-Rehbrucke (DE); Katharina Landfester, Ulm (DE)

Correspondence Address: OBLON, SPIVAK, MCCLELLAND, MAIER & NEUSTADT, P.C., 1940 DUKE STREET, ALEXANDRIA, VA, 22314, US

(73) Assignees: BASF AKTIENGESELLSCHAFT, LUDWIGSHAFEN (DE); MAX-PLANCK-GESELLSCHAFT ZUR FOERD DER WISSEN E.V., MUENCHEN (DE)

(21) Appl. No.: 10/583,097

(22) PCT Filed: Dec. 16, 2004
(86) PCT No.: PCT/EP04/14327

§ 371 Date: Jun. 16, 2006

(30) Foreign Application Priority Data
Dec. 18, 2003 (DE) 103 60 043.4

(51) Int. Cl. B32B 5/16

(52) U.S. Cl. 428/403; 528/44

(57) ABSTRACT

A process for producing aqueous primary dispersions of polymer-ensheathed pigment, which comprises (a) at least one polyfunctional isocyanate and (b) at least one compound having isocyanate-reactive groups selected from polyetherols, polyesterols, polyhydric alcohols having up to 8 carbon atoms, polycarbonate diols, polyhydroxyolefins, polyhydroxyurethanes, polyisobutenediols, polysiloxanes having on average at least 2 hydroxyl groups per molecule and lactone-based polyesterdiols being mixed with pigment, water and if appropriate one or more surface-active substances and reacted with each other.

The present invention relates to a process for producing aqueous primary dispersions of polymer-ensheathed pigment, which comprises
(a) at least one polyfunctional isocyanate and
(b) at least one compound having isocyanate-reactive groups selected from polyetherols, polyesterols, polyhydric alcohols having up to 8 carbon atoms, polycarbonate diols, polyhydroxyolefins, polyhydroxyurethanes, polyisobutenediols, polysiloxanes having on average at least 2 hydroxyl groups per molecule and lactone-based polyesterdiols
   being mixed with pigment, water and if appropriate one or more surface-active substances and reacted with each other.

Aqueous dispersions of pigments are widely used, for example for coloring textiles and leather. Examples which may be mentioned are use as or in inks for the ink jet process, the use as or in print pastes for textile printing processes and also the use in the finishing of leather. Pigment dispersions for state of the art applications have to meet demanding requirements as regards for example the stability of the dispersion as such and as regards the later planned application. For instance, aqueous dispersions shall be very stable and not tend to coagulate for example. The pigment dispersions shall be simple to apply. Applied pigments shall have very good fastnesses. Lastly, the dispersions in question shall be simple to produce.

Pigments as such generally do not form stable dispersions in water which meet the high requirements. Dispersants are therefore used to try and disperse them.

M. Antonietti, at the In-Cosmetics event held in Paris on Apr. 3-4, 2003 and at the “Nanotechnologie für Beschichtungen” [Nanotechnology for coatings] conference held on Jun. 12, 2003, proposed coating carbon black with polyurethanes prepared by polyaddition of isophorone diisocyanate and 1,12-dodecanediol in miniemulsion. However, the disclosed ensheathed carbon black is not suitable for the ink jet process, and the rub fastnesses of printed textiles are only moderate. The polyurethanes obtained are generally too brittle.

The reference F. Tiarks et al., Macromol. Chem. Phys. 2001, 202, 51 ff. discloses that carbon black can be encapsulated by polymers prepared by polymerization of polyurethanes from a polyesterol and isophorone diisocyanate in 2-butanone, isolated by evaporating the ketone, taken up in cyclohexane, dried and isolated by evaporating the cyclohexane. The polyurethanes thus prepared can be converted by means of surfactant and ultrasonication into a miniemulsion in which carbon black can be dispersed. However, the process disclosed is fairly complicated.

Bechthold et al. propose in Macromol. Chem. Phys. 2000, 155, 549 ff. encapsulating CaCO₃ and carbon black with polystyrene prepared by miniemulsion polymerization. However, the mechanical properties of the encapsulated carbon black thus obtainable are inadequate for practical purposes; durable coatings cannot be produced.

The present invention thus has for its object to provide a process for producing dispersed pigments which avoids the abovementioned disadvantages. The present invention further has for its object to provide dispersed pigments. The present invention lastly has for its object to provide uses for dispersed pigments.

We have found that this object is achieved by the process defined at the beginning.

Useful polyfunctional isocyanates (a) include in the main diisocyanates, but also compounds having three or four isocyanate groups. Particularly preferred diisocyanates are for example aromatic and aliphatic diisocyanates. As aromatic di- and triisocyanates there may be mentioned 2,4-tolylene diisocyanate (2,4-TDI), 4,4′-diphenylmethane diisocyanate (4,4′-MDI), para-xylylene diisocyanate, 1,4-diisocyanatobenzene, tetramethylxylylene diisocyanate (TMXDI), 2,4′-diphenylmethane diisocyanate (2,4′-MDI) and triisocyanatotoluene, as aliphatic diisocyanates there may be mentioned for example isophorone diisocyanate (IPDI), 2-butyl-2-ethylpentamethylene diisocyanate, tetramethylene diisocyanate, hexamethylene diisocyanate, dodecamethylene diisocyanate, 2,2-bis(4-isocyanatocyclohexyl)propane, 2,2,4-trimethylhexane diisocyanate, 2,4,4-trimethylhexane diisocyanate and mixtures of the aforementioned trimethylhexane diisocyanates, 2-isocyanatopropylcyclohexyl isocyanate, 2,4,4- and 2,2,4-trimethylhexamethylene diisocyanate, 2,4′-methylenebis(cyclohexyl) diisocyanate, cis-cyclohexane 1,4-diisocyanate, trans-cyclohexane 1,4-diisocyanate and 4-methylcyclohexane 1,3-diisocyanate (H-TDI).

Mixtures of the aforementioned polyfunctional isocyanates also come into consideration of course. As mixtures of the aforementioned polyfunctional isocyanates are mentioned in particular mixtures of structural isomers of 2,4-tolylene diisocyanate and triisocyanatotoluene, for example mixtures of 80 mol% of 2,4-tolylene diisocyanate and 20 mol % of 2,6-tolylene diisocyanate or mixtures of cis- and trans-cyclohexane 1,4-diisocyanate; also mixtures of 2,4-tolylene diisocyanate or 2,6-tolylene diisocyanate with aliphatic diisocyanates such as for example hexamethylene diisocyanate and isophorone diisocyanate.

As polyfunctional isocyanates (a) it is further possible to use polyfunctional isocyanates which, as well as free isocyanate groups, comprise capped isocyanate groups, for example isocyanurate, biuret, urea, allophanate, uretidione or carbodiimide groups.

Among compounds having isocyanate-reactive groups (b), at least one compound is selected from polyetherols, polyesterols, polyhydric alcohols having up to 8 carbon atoms, polycarbonate diols, polyhydroxyolefins, polyhydroxyurethanes, polyisobutenediols, polysiloxanes having on average at least 2 hydroxyl groups per molecule and lactone-based polyesterdiols.

Compounds having isocyanate-reactive groups are preferably compounds having on average at least two isocyanate-reactive groups per molecule. However, compounds (b) may also comprise more than two isocyanate-reactive groups per molecule.

Polyetherols are obtainable for example by addition polymerization of ethylene oxide, propylene oxide, butylene oxide, tetrahydrofuran, styrene oxide or epichlorohydrin in the presence of a suitable catalyst such as BF₃ for example. Similarly, polyetherols obtainable by copolymerization of one or more of the aforementioned compounds are suitable. Also suitable are polyetherols which are obtainable by addition polymerization of at least one of the aforementioned compounds in the presence of a compound having at least two acidic hydrogen atoms, for example in the presence of water, ethylene glycol, thioglycol, mercaptoethanol, 1,3-propanediol, 1,4-butanediol, 1,6-hexanediol, 1,12-dodecanediol, ethylenediamine, aniline or 1,2-di(4-hydroxyphenyl)propane.

Preferred polyetherols are selected for example from polyethylene glycol, polypropylene glycol, polybutylene glycol, polytetrahydrofuran and also mixed products obtainable for example by reaction of ethylene oxide and propylene oxide in the presence of BF₃. Suitable polyetherols further include reaction products of with C₁-C₄-alkylene oxide, especially with ethylene oxide. Preferred polyetherols can have a molecular weight Mn in the range from 250 to 5000 g/mol and more preferably in the range from 500 to 2500 g/mol.

Preferred polyesterols are described for example in Ullmann's Encyclopedia of Industrial Chemistry, 5th edition, volume A21, pages 228-230 under “Hydroxypolyester”; the terms polyesterols and hydroxypolyester will be used as equivalent in what follows. Preference is given to using polyesterols which by reaction of dihydric alcohols with dibasic carboxylic acids or reactive derivatives of dibasic carboxylic acids, for example with anhydrides or dimethyl esters of dibasic carboxylic acids. The dibasic carboxylic acids used and their reactive derivatives may derive from aromatic or aliphatic dibasic carboxylic acids, and they may bear one or more substituents. Examples of suitable dibasic carboxylic acids are suberic acid, adipic acid, azelaic acid, phthalic acid, isophthalic acid, terephthalic acid, maleic acid, fumaric acid, succinic acid, glutaric acid, sebacic acid, 1,12-dodecanedicarboxylic acid, alkenylsuccinic acid such as for example methylenesuccinic acid (itaconic acid). Very particularly preferred anhydrides are for example phthalic anhydride, tetrahydrophthalic anhydride, hexahydrophthalic anhydride, tetrachlorophthalic anhydride, endomethylenetetrahydrophthalic anhydride. Particularly preferred dimethyl esters are for example dimethyl terephthalate and dimethyl isophthalate.

Particularly preferred polybasic aliphatic carboxylic acids are those of the general formula
HOOC—(CH₂)ₓ—COOH
where x is an integer in the range from 1 to 20 and preferably from 2 to 10.

Useful polyhydric alcohols for constructing polyesterols include for example ethylene glycol, propylene glycol, 1,3-propanediol, butylene glycol, 1,4-butanediol, 1,5-pentanediol, 1,6-hexanediol, neopentylglycol, cis-but-2-ene-1,4-diol, trans-but-2-ene-1,4-diol, 2-butyne-1,4-diol, 2-methylpropane-1,3-diol, 1,8-octanediol, 1,10-decanediol, 1,12-dodecanediol, di(hydroxymethyl)cyclohexanes such as for example cis- and trans-1,4-di(hydroxymethyl)cyclohexane. Preference is given to diols of the general formula
HO—(CH₂)_{y}—OH
where y is an integer in the range from 2 to 8 and preferably from 2 to 4.

Particularly useful polyesterols may have a molecular weight Mₙ in the range from 500 g/mol to 5000 g/mol.

Compounds (b) may be further selected from polyhydric alcohols having up to 8 carbon atoms, polycarbonate diols, polyhydroxyolefins, polyhydroxyurethanes, polyisobutenediols, polysiloxanes having on average at least 2 hydroxyl groups per molecule and lactone-based polyesterdiols.

Polyhydric alcohols having up to 8 carbon atoms that are useful as examples are in particular diols having up to 8 carbon atoms such as for example ethylene glycol, propylene glycol, 1,3-propanediol, butylene glycol, 1,4-butanediol, 1,5-pentanediol, 1,6-hexanediol, neopentylglycol, cis-but-2-ene-1,4-diol, trans-but-2-ene-1,4-diol, 2-butyne-1,4-diol, 2-methylpropane-1,3-diol, 1,8-octanediol, di(hydroxymethyl)-cyclohexanes such as for example cis- and trans-1,4-di(hydroxymethyl)cyclohexane.

Preference is given to diols of the general formula
HO—(CH₂)_{y}—OH
where y is an integer in the range from 2 to 8 and preferably from 2 to 4. But trihydric, tetrahydric, 5-hydric and up to 8-hydric alcohols are suitable as well, examples being glycerol, trimethylolethane, trimethylolpropane, trimethylol-n-butane, sorbitol.

Suitable polycarbonate diols are obtainable for example by reaction of phosgene with an excess of diols, preferably of diols having up to 8 carbon atoms and more preferably with diols of the general formula
HO—(CH₂)_{y}—OH
where y is as defined above.

Examples of suitable polyhydroxyolefins are α,ω-dihydroxybutadienes and products of the reaction of poly(meth)acrylates with diols. α,ω-Dihydroxy(meth)acrylates are particularly preferred.

Suitable α,ω-dihydroxymethacrylates are disclosed for example in EP-A 0 622 378; the synthesis of analogously constructed α,ω-dihydroxyacrylates is achieved analogously.

Suitable polyhydroxyurethanes are for example hyperbranched polyurethanes as described in EP 1 026 185 A1 as hydroxyl-functional dendrimeric or highly branched polyurethanes and EP 1 167 413 A1 as polyfunctional polyisocyanate addition products.

Suitable polyisobutenediols are for example those described in Kennedy et al., Carbocationic Macromolecular Engineering, Hauser Verlag, page 177.

There may further be mentioned polysiloxanes having on average at least two OH groups per molecule, suitable polysiloxanes having on average one to one hundred silicon atoms (number average) and being substituted with C₁-C₁₂-alkyl groups or with phenyl groups, preferably with methyl groups or with phenyl groups.

As examples of suitable lactone-based polyesterdiols are obtainable for example by polycondensation of compounds of the general formula 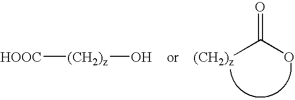
where z is an integer in the range from 1 to 20 and preferably from 2 to 7 and one or as the case may be more CH₂ groups may be replaced by CH—C₁-C₄-alkyl, which is initiated with diol, for example an α,ω-C₂-C₁₂-alkylenediol such as for example ethylene glycol, 1,4-butanediol, 1,6-hexanediol or 1,12-dodecanediol.

A specific embodiment of the present invention utilizes as compounds having isocyanate-reactive groups one or more additional compounds having ionic or nonionic (potentially) hydrophilic groups.

(Potentially) hydrophilic groups may be nonionic hydrophilic groups or preferably (potentially) ionic hydrophilic groups.

Useful compounds having nonionic hydrophilic groups include in particular polyethylene glycol having preferably from 5 to 100 and more preferably from 10 to 80 ethylene oxide repeat units per molecule (weight average). The level of polyethylene oxide used may be for example in the range from 0% to 10% and preferably from 0% to 6% by weight, based on the sum total of (a)+(b).

Other preferred additional compounds having nonionic hydrophilic groups are reaction products of a polyethylene glycol and a polyisocyanate that bear a terminally etherified polyethylene glycol radical. Such polyisocyanates and their methods of making are described in U.S. Pat. No. 3,905,929 and U.S. Pat. No. 3,920,598.

Ionic hydrophilic groups are in particular anionic groups such as the sulfonate, the carboxylate and the phosphate group in the form of their alkali metal or ammonium salts and also cationic groups such as ammonium groups, especially protonated tertiary amino groups and quaternary ammonium groups.

Potentially ionic hydrophilic groups are in particular those which can be converted by neutralization, hydrolysis or quaternization reactions into the abovementioned ionic hydrophilic groups, for example carboxylic acid groups or tertiary amino groups.

Preferred additional compounds having potentially ionic groups are described for example in Ullmanns Encyklopadie der technischen Chemie, 4th edition, volume 19, pages 311-313 and for example in DE-A 14 95 745, at length.

Especially compounds having tertiary amino groups are of particular practical importance for use as additional compounds having potentially cationic groups, examples being tris(hydroxyalkyl)amines, N,N′-bis(hydroxyalkyl)alkylamines, N-hydroxyalkyldialkylamines, tris(aminoalkyl)amines, N,N′-bis(aminoalkyl)alkylamines, N-aminoalkyldialkylamines, wherein the alkyl radicals and alkanediyl units of these tertiary amines independently consist of 1 to 6 carbon atoms. Also suitable are polyethers having tertiary nitrogen atoms and preferably two terminal hydroxyl groups, as obtainable in a conventional manner, for example by alkoxylation of amines having two hydrogen atoms attached to amine nitrogen, for example methylamine, aniline or N,N′-dimethylhydrazine. Such polyethers generally have a molecular weight between 500 and 6000 g/mol.

The abovementioned tertiary amines are converted into the ammonium salts either with acids, preferably strong mineral acids such as phosphoric acid, sulfuric acid, hydrohalic acids or strong organic acids or by reaction with suitable quaternizing agents such as C₁- to C₆-alkyl halides or benzyl halides, for example bromides or chlorides.

Useful additional compounds having potentially anionic groups customarily include aliphatic, cycloaliphatic, araliphatic or aromatic carboxylic acids and sulfonic acids which bear at least one alcoholic hydroxyl group or at least one primary or secondary amino group. Preference is given to dihydroxyalkylcarboxylic acids, especially having from 3 to 10 carbon atoms, as also described in U.S. Pat. No. 3,412,054. Particular preference is given to compounds of the general formula I 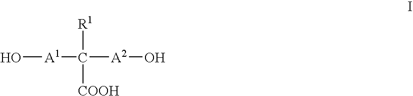
where A¹ and A² are each a C₁- to C₄-alkandiyl unit, identical or different, and R¹ is a C₁- to C₄-alkyl unit or hydrogen, and especially dimethylolpropionic acid (DMPA).

Also suitable are the corresponding dihydroxysulfonic acids and dihydroxyphosphonic acids such as 2,3-dihydroxypropanephosphonic acid.

It is further possible to use dihydroxy compounds having a molecular weight from 500 to 10 000 g/mol and at least 2 carboxylate groups, known from DE-A 39 11 827. They are obtainable by reaction of dihydroxy compounds with tetracarboxylic dianhydrides such as pyromellitic dianhydride or cyclopentanetetracarboxylic dianhydride in a molar ratio from 2:1 to 1.05:1 in a polyaddition reaction. Suitable dihydroxy compounds are in particular the monomers (b2) cited as chain extenders and also the diols (b1) from DE 39 11 827.

One embodiment of the present invention utilizes the components (a) and (b) in a molar ratio from 0.8:1 to 3:1 and preferably from 0.9:1 to 1.5:1 and most preferably in a molar ratio of 1:1.

One embodiment of the present invention may also involve adding up to 10 mol %, based on (a), of compounds which have just one isocyanate-reactive group, for example monoalcohols, primary or secondary monoamines or mercaptans.

The process of the present invention also utilizes at least one pigment. Pigments for the purposes of the present invention are virtually insoluble, finely dispersed, organic or inorganic colorants as per the definition in German standard specification DIN 55944. The process of the present invention preferably utilizes organic pigments, which includes carbon black. There now follow examples of suitable pigments.

Organic Pigments:
monoazo pigments: C.I. Pigment Brown 25; C.I. Pigment Orange 5, 13, 36 and 67; C.I. Pigment Red 1, 2, 3, 5, 8, 9, 12, 17, 22, 23, 31, 48:1, 48:2, 48:3, 48:4, 49, 49:1, 52:1, 52:2, 53, 53:1, 53:3, 57:1, 63, 112, 146, 170, 184, 210, 245 and 251; C.I. Pigment Yellow 1, 3, 73, 74, 65, 97, 151 and 183;
disazo pigments: C.I. Pigment Orange 16, 34 and 44; C.I. Pigment Red 144, 166, 214 and 242; C.I. Pigment Yellow 12, 13, 14, 16, 17, 81, 83, 106, 113, 126, 127, 155, 174, 176 and 188;
anthanthrone pigments: C.I. Pigment Red 168 (C.I. Vat Orange 3);
anthraquinone pigments: C.I. Pigment Yellow 147 and 177; C.I. Pigment Violet 31;
anthraquinone pigments: C.I. Pigment Yellow 147 and 177; C.I. Pigment Violet 31;
anthrapyrimidine pigments: C.I. Pigment Yellow 108 (C.I. Vat Yellow 20);
quinacridone pigments: C.I. Pigment Red 122, 202 and 206; C.I. Pigment Violet 19;
quinophthalone pigments: C.I. Pigment Yellow 138;
dioxazine pigments: C.I. Pigment Violet 23 and 37;
flavanthrone pigments: C.I. Pigment Yellow 24 (C.I. Vat Yellow 1);
indanthrone pigments: C.I. Pigment Blue 60 (C.I. Vat Blue 4) and 64 (C.I. Vat Blue 6);
isoindoline pigments: C.I. Pigment Orange 69; C.I. Pigment Red 260; C.I. Pigment Yellow 139 and 185;
isoindolinone pigments: C.I. Pigment Orange 61; C.I. Pigment Red 257 and 260; C.I. Pigment Yellow 109,110,173 and 185;
isoviolanthrone pigments: C.I. Pigment Violet 31 (C.I. Vat Violet 1);
metal complex pigments: C.I. Pigment Yellow 117,150 and 153; C.I. Pigment Green 8;
perinone pigments: C.I. Pigment Orange 43 (C.I. Vat Orange 7); C.I. Pigment Red 194 (C.I. Vat Red 15);
perylene pigments: C.I. Pigment Black 31 and 32; C.I. Pigment Red 123,149,178,179 (C.I. Vat Red 23), 190 (C.I. Vat Red 29) and 224; C.I. Pigment Violet 29;
phthalocyanine pigments: C.I. Pigment Blue 15, 15:1, 15:2, 15:3, 15:4, 15:6 and 16; C.I. Pigment Green 7 and 36;
pyranthrone pigments: C.I. Pigment Orange 51; C.I. Pigment Red 216 (C.I. Vat Orange 4);
thioindigo pigments: C.I. Pigment Red 88 and 181 (C.I. Vat Red 1); C.I. Pigment Violet 38 (C.I. Vat Violet 3);
triarylcarbonium pigments: C.I. Pigment Blue 1, 61 and 62; C.I. Pigment Green 1; C.I. Pigment Red 81, 81:1 and 169; C.I. Pigment Violet 1, 2, 3 and 27; C.I. Pigment Black 1 (aniline black); C.I. Pigment Yellow 101 (aldazine yellow); C.I. Pigment Brown 22.

Inorganic Pigments:
white pigments: titanium dioxide (C.I. Pigment White 6), zinc white, pigment grade zinc oxide; zinc sulfide, lithopone; lead white;
black pigments: iron oxide black (C.I. Pigment Black 11), iron manganese black, spinell black (C.I. Pigment Black 27); carbon black (C.I. Pigment Black 7);
chromatic pigments: chromium oxide, chromium oxide hydrate green; chrome green (C.I. Pigment Green 48); cobalt green (C.I. Pigment Green 50); ultramarine green; cobalt blue (C.I. Pigment Blue 28 and 36); ultramarine blue; iron blue (C.I. Pigment Blue 27); manganese blue; ultramarine violet; cobalt violet, manganese violet; iron oxide red (C.I. Pigment Red 101); cadmium sulfoselenide (C.I. Pigment Red 108); molybdate red (C.I. Pigment Red 104); ultramarine red;
   iron oxide brown, mixed brown, spinell and corundum phases (C.I. Pigment Brown 24, 29 and 31), chrome orange;
   iron oxide yellow (C.I. Pigment Yellow 42); nickel titanium yellow (C.I. Pigment Yellow 53; C.I. Pigment Yellow 157 and 164); chrome titanium yellow; cadmium sulfide and cadmium zinc sulfide (C.I. Pigment Yellow 37 and 35); chrome yellow (C.I. Pigment Yellow 34), zinc yellow, alkaline earth metal chromates; Naples yellow; bismuth vanadate (C.I. Pigment Yellow 184);
interference pigments: metallic effect pigments based on coated metal platelets; pearl luster pigments based on mica platelets coated with metal oxide; liquid crystal pigments.

Preferred pigments in this context are monoazo pigments (especially laked BONS pigments, naphthol AS pigments), disazo pigments (especially diaryl yellow pigments, bisacetoacetanilide pigments, disazopyrazolone pigments), quinacridone pigments, quinophthalone pigments, perinone pigments, phthalocyanine pigments, triarylcarbonium pigments (alkali blue pigments, laked rhodamines, dye salts with complex anions), isoindoline pigments and carbon blacks.

Specific examples of particularly preferred pigments are: carbon black, C.I. Pigment Yellow 138, C.I. Pigment Red 122 and 146, C.I. Pigment Violet 19, C.I. Pigment Blue 15:3 and 15:4, C.I. Pigment Black 7, C.I. Pigment Orange 5, 38 and 43 and C.I. Pigment Green 7.

The process of the present invention utilizes one or more pigments in particulate form, i.e., in the form of particles.

The process of the present invention is preferably carried out using predispersed pigment as a starting material; that is, one or more pigments are dispersed in an apparatus with at least one additive, for example at least one solvent, for example water, C₁-C₄-alkanol, polyetherol, diethylene glycol, triethylene glycol, tetraethylene glycol, n-butyl acetate before mixing with (a) and (b). It is further possible to predisperse using dispersing additives. Useful dispersing additives include for example emulsifiers as more particularly described hereinbelow. Other suitable additives are biocides, for example 1,2-benzisothiazolin-3-one (BIT) (commercially available as Proxel® brands from Avecia Lim.) or its alkali metal salts; other suitable biocides are 2-methyl-2H-isothiazole-3 (MIT) and 5-chloro-2-methyl-2H-isothiazol-3-one (CIT).

Useful apparatuses include for example ball mills, stirred media mills, ultrasonifiers, high pressure homogenizers and Ultra Thurax stirrers.

An example of a suitable predispersing time is in the range from ½ an hour to 48 hours, but longer times are conceivable. The predispersing time is preferably in the range from 1 to 24 hours.

Predispersing pressure and temperature conditions are generally not critical in that, for example, atmospheric pressure has been found to be suitable. As for temperatures, temperatures in the range from 10° C. to 100° C. for example have been found to be suitable.

The weight ratio of pigment to water can be chosen within wide limits and may be for example in the range from 1:10 to 1:2.

Customary grinding assistants may be added during the predispersing.

The average diameter of pigment used according to the present invention is typically in the range from 10 nm to 1.5 μm, preferably in the range from 60 to 200 nm and more preferably in the range from 15 to 150 nm after predispersing.

When carbon black is to be used in accordance with the present invention, the average particle diameter refers to the average diameter of the primary particles.

The weight ratio of pigment to the sum total of (a) and (b) may be in the range from 1:10 to 10:1, preferably in the range from 1:3 to 3:1 and more preferably in the range from 1:2 to 2:1.

In the present invention, (a), (b) and pigment are mixed with water. Salt-containing water may be used, but it is preferable to use completely ion-free water, which is obtainable with the aid of ion exchangers or by distillation for example.

The process of the present invention may be carried out by mixing with one or more surface-active substances, hereinafter also known as emulsifiers.

Emulsifiers used may be selectively anionic, cationic or nonionic emulsifiers. Suitable emulsifiers are described for example in Houben-Weyl, Methoden der Organischen Chemie, volume XIV/1 (Makromolekulare Stoffe), Georg-Thieme-Verlag Stuttgart 1961, pages 192-208.

-Suitable nonionic emulsifiers are for example ethoxylated mono-, di- and trialkylphenols (degree of ethoxylation: 3 to 50, alkyl radical: C₄-C₁₂) and also ethoxylated fatty alcohols (degree of ethoxylation: 3 to 80; alkyl radical: C₈-C₃₆). Examples are the Lutensol® brands from BASF Aktiengesellschaft and the Triton® brands from Union Carbide.

Suitable anionic emulsifiers are for example alkali metal and ammonium salts of alkyl sulfates (alkyl radical: C₈ to C₁₂), of acid sulfuric esters of ethoxylated alkanols (degree of ethoxylation: 4 to 30, alkyl radical: C₁₂-C₁₈) and ethoxylated alkylphenols (degree of ethoxylation: 3 to 50, alkyl radical: C₄-C₁₂), of alkylsulfonic acids (alkyl radical: C₁₂-C₁₈) and of alkylarylsulfonic acids (alkyl radical: C₉-C₁₈).

Suitable cationic emulsifiers are in general C₆-C₁₈-alkyl-, -aralkyl- or heterocycyl-containing primary, secondary, tertiary or quaternary ammonium salts, alkanol ammonium salts, pyridinium salts, imidazolinium salts, oxazolinium salts, morpholinium salts, thiazolinium salts and also salts of amine oxides, quinolinium salts, isoquinolinium salts, tropylium salts, sulfonium salts and phosphonium salts. Examples which may be mentioned are dodecylammonium acetate or the corresponding hydrochloride, the chlorides or acetates of the various 2-(N,N,N-trimethylammonium)ethylparaffinic esters, N-cetylpyridinium chloride, N-laurylpyridinium sulfate and also N-cetyl-N,N,N,-trimethylammonium bromide, N-dodecyl-N,N,N-trimethylammonium bromide, N,N-distearyl-N,N-dimethylammonium chloride and also the Gemini surfactant N,N-(lauryldimethyl)ethylenediamine dibromide. Numerous further examples are to be found in H. Stache, Tensid-Taschenbuch, Carl-Hanser-Verlag, Munich, Vienna, 1981 and in McCutcheon's, Emulsifiers & Detergents, MC Publishing Company, Glen Rock, 1989.

The amount of emulsifier to carry out the process of the present invention may be chosen such that the critical micelle formation concentration of the emulsifiers concerned is not significantly exceeded in the aqueous macro- or miniemulsion ultimately formed. However, larger amounts of emulsifier may be used as well, for example up to 30% by weight, preferably up to 20% by weight and more preferably up to 10% by weight, based on the sum total of (a) and (b).

In a specific embodiment of the present invention the amount of emulsifier is in the range from 0.1% to 5% by weight, based on the sum total of (a) and (b).

There is an embodiment of the present invention where one or more hydrophobic liquids can be used as costabilizers to carry out the process according to the present invention.

Useful hydrophobic liquids (costabilizers) include materials whose solubility in water at 25° C. or under process conditions according to the present invention is not more than 5×10⁻⁵ g/l and preferably not more than 5×10⁻⁷ g/l. Particularly suitable examples are hydrocarbons such as for example n-hexadecane, n-tetradecane, n-dodecahedrane, halogenated hydrocarbons such as for example chlorobenzene, hydrophobic oils such as for example olive oil, siloxanes without free OH groups and silanes. Similarly, blocked polyisocyanates may be used as costabilizers.

One embodiment of the present invention utilizes from 0.01% to 10% by weight and preferably from 0.1% to 5% by weight of at least one costabilizer, based on the sum total of (a) and (b) present in the aqueous miniemulsion. There is another embodiment where the use of costabilizer is dispensed with.

There is an embodiment of the present invention where one or more protective colloids are added in the course of mixing. Useful protective colloids include those protective colloids which are described in Houben-Weyl, Methoden der Organischen Chemie, volume XIV/1 (Makromolekulare Stoffe), Georg-Thieme-Verlag Stuttgart 1961, pages 411-420.

The amount of protective colloid in one embodiment of the present invention is in the range from 0% to 50% by weight and preferably from 1% to 30% by weight, based on the sum total of (a) and (b) present in the aqueous miniemulsion.

Mixing in accordance with the present invention at least one polyfunctional isocyanate (a), at least one compound having isocyanate-reactive groups (b), pigment, water and if appropriate one or more surface-active substances gives a macroemulsion or preferably a miniemulsion.

Macroemulsions for the purposes of the present invention are multiphasic mixtures where the average diameter of the monomer droplets is in the range from above 1 μm to 1 mm. Miniemulsions for the purposes of the present invention are such multiphasic mixtures where the average diameter of the monomer droplets is in the range from 20 to 1000 nm, preferably in the range from 40 to 500 nm and more preferably in the range from 60 to 200 nm. The average diameter of the monomer droplets is measured for example by the method of quasielastic light scattering (the so-called z-average monomer droplet diameter dz of the unimodal analysis of the autocorrelation function).

The average diameter of the monomer droplets shall on addition of protective colloids, emulsifiers and/or hydrophobic liquids (costabilizers) refer to the average diameter of the droplets not only of the monomers as such but of all hydrophobic components which are emulsified in water.

To react (a) and (b) with each other after mixing, mixing may be followed by heating or use of one or more catalysts or heating and use of one or more catalysts.

Useful catalysts include typical polyurethane chemistry catalysts.

Examples of typical polyurethane chemistry catalysts are organic amines, especially tertiary aliphatic, cycloaliphatic or aromatic amines, and Lewis-acidic organic compounds of metals.

Examples of Lewis-acidic organic compounds of metals include tin compounds, for example tin(II) salts of organic carboxylic acids, for example tin(II) acetate, tin(II) octanoate, tin(II) ethylhexanoate and tin(II) laurate and the dialkyltin(IV) derivatives of organic carboxylic acids, for example dimethyltin diacetate, dibutyltin diacetate, dibutyltin dibutyrate, dibutyltin bis(2-ethylhexanoate), dibutyltin dilaurate, dibutyltin maleate, dioctyltin dilaurate and dioctyltin diacetate. Metal complexes such as acetylacetonates of iron, of titanium, of aluminum, of zirconium, of manganese, of nickel and of cobalt are possible as well. Further metal catalysts are described by Blank et al. in Progress in Organic Coatings, 1999, 35, 19 ff.

Preferred Lewis-acidic organic compounds of metals are dimethyltin diacetate, dibutyltin dibutyrate, dibutyltin bis(2-ethylhexanoate), dibutyltin dilaurate, dioctyltin dilaurate, zirconium acetylacetonate and zirconium 2,2,6,6-tetramethyl-3,5-heptanedionate.

Similarly, bismuth and cobalt catalysts and also cesium salts can be used as catalysts. Useful cesium salts include those compounds which utilize the following anions: F⁻, Cl⁻, ClO⁻, ClO₃⁻, ClO₄⁻, Br⁻, J⁻, JO₃⁻, CN⁻, OCN⁻, NO₂⁻, NO₃⁻, HCO₃⁻, CO₃²⁻, S²⁻, SH⁻, HSO₃⁻, SO₃²⁻, HSO₄⁻, SO₄²⁻, S₂O₂²⁻, S₂O₄²⁻, S₂O₅²⁻, S₂O₆²⁻, S₂O₇²⁻, S₂O₈²⁻, H₂PO₂⁻, H₂PO₄⁻, HPO₄²⁻, PO₄³⁻, P₂O₇⁴⁻, (OCₙH₂ₙ₊₁)⁻, (CₙH₂ₙ₋₂O₂)⁻, (CₙH₂ₙ₋₃O₂)⁻ and also (Cₙ₊₁H₂ₙ₋₂O₄)²⁻, wherein n represents numbers from 1 to 20.

Preference is given to cesium carboxylates in which the anion conforms to the formulae (CₙH₂ₙ₋₁O₂)⁻ and also (Cₙ₊₁H₂ₙ₋₂O₄)²⁻ where n is 1 to 20. Particularly preferred cesium salts comprise monocarboxylates of the general formula (CₙH₂ₙ₋₁O₂)⁻, where n represents numbers from 1 to 20, as anions. Formate, acetate, propionate, hexanoate and 2-ethylhexanoate must be mentioned in particular.

As customary organic amines there may be mentioned by way of example: triethylamine, 1,4-diazabicyclo[2,2,2]octane, tributylamine, dimethylbenzylamine, N,N,N′,N′-tetramethylethylenediamine, N,N,N′,N′-tetramethylbutane-1,4-diamine, N,N,N′,N′-tetramethylhexane-1,6-diamine, dimethylcyclohexylamine, dimethyidodecylamine, pentamethyldipropylenetriamine, pentamethyldiethylenetriamine, 3-methyl-6-dimethylamino-3-azapentol, dimethylaminopropylamine, 1,3-bisdimethylaminobutane, bis(2-dimethylaminoethyl) ether, N-ethylmorpholine, N-methylmorpholine, N-cyclohexylmorpholine, 2-dimethylaminoethoxyethanol, dimethylethanolamine, tetramethylhexamethylenediamine, dimethylamino-N-methylethanolamine, N-methylimidazole, N-formyl-N,N′-dimethylbutylenediamine, N-dimethylaminoethylmorpholine, 3,3′-bisdimethylamino-di-n-propylamine and/or 2,2′-dipiparazine diisopropyl ether, dimethylpiparazine, tris(N,N-dimethylaminopropyl)-s-hexahydrotriazine, imidazoles such as 1,2-dimethylimidazole, 4-chloro-2,5-dimethyl-1-(N-methylaminoethyl)imidazole, 2-aminopropyl-4,5-dimethoxy-1-methylimidazole, 1-aminopropyl-2,4,5-tributylimidazole, 1-aminoethyl-4-hexylimidazole, 1-aminobutyl-2,5-dimethylimidazole, 1-(3-aminopropyl)-2-ethyl-4-methylimidazole, 1-(3-aminopropyl)imidazole and/or 1-(3-aminopropyl)-2-methylimidazole.

Preferred organic amines are trialkylamines having independently two C₁- to C₄-alkyl radicals and one alkyl or cycloalkyl radical having 4 to 20 carbon atoms, for example dimethyl-C₄-C₁₅-alkylamine such as dimethyidodecylamine or dimethyl-C₃-C₈-cycloalkylamine. Likewise preferred organic amines are bicyclic amines which may if appropriate comprise a further heteroatom such as oxygen or nitrogen, an example being 1,4-diazabicyclo[2,2,2]octane.

It will be appreciated that mixtures of two or more of the aforementioned compounds may be used as catalysts as well.

Particular preference is given to using hydrophobic catalysts selected from the aforementioned compounds.

Catalysts are preferably used in an amount from 0.0001% to 10% by weight and more preferably in an amount from 0.001% to 5% by weight, based on the sum total of (a) and (b).

The catalyst or catalysts may be added in solid or liquid form or in solution, depending on the constitution of the catalyst or catalysts. Suitable solvents are water-immiscible solvents such as aromatic or aliphatic hydrocarbons such as for example toluene, ethyl acetate, hexane and cyclohexane and also carboxylic esters such as for example ethyl acetate. Suitable solvents are also water-miscible solvents such as acetone and THF. Preference is given to adding the catalyst or catalysts in solid or liquid form.

A preferred embodiment of the present invention comprises combining (a), (b), pigment, water, if appropriate one or more surface-active substances, if appropriate protective colloid and if appropriate costabilizer to prepare a miniemulsion. It is preferable in this connection to prepare the miniemulsion by introducing strong shearing forces into a previously prepared macroemulsion. It is possible to introduce strong shearing forces once or repeatedly.

Miniemulsions may be prepared according to various methods. The methods have in common that (a), (b), water, if appropriate emulsifier, protective colloid, costabilizer and predispersed pigment are mixed with one another and exposed to strong shearing forces. It is possible in this connection for all components to be mixed with one another at one and the same time and thereafter be exposed to strong shearing forces, or first to mix some of the components such as for example predispersed pigment, (b), water and emulsifier, to expose them to strong shearing forces and only then to add the remaining components.

Strong shearing forces can be introduced by various methods. Suitable methods utilize for example cavitation mechanisms or exploit pressure gradients or shear gradients.

One embodiment of the present invention comprises mixing water with at least two more of the components (a), (b), emulsifier, protective colloid, costabilizer and predispersed pigment to form a macroemulsion. The macroemulsion thus prepared is subsequently pressurized to pressures of at least 500 bar, preferably at least 1000 bar, for example by means of a piston pump, and subsequently relaxed through one or more slots or one or more perforated plates to obtain a miniemulsion. High shearing and pressure gradients can be observed and also cavitation in the slot.

Suitable apparatuses for carrying out the thus described introduction of strong shearing forces are slot homogenizers, for example the Niro Soavi high pressure homogenizer NS1001L Panda, and perforated plates, for example described in EP 1008 380 A2.

Another embodiment of the present invention comprises mixing water with at least two more of the components (a), (b), emulsifier, protective colloid, costabilizer and predispersed pigment to form a macroemulsion. The macroemulsion thus prepared is subsequently pressurized to pressures of at least 500 bar, preferably at least 1000 bar, particularly preferably at least 1200 bar, for example by means of a piston pump, and subsequently relaxed through at least two nozzles or at least two valves into a mixing chamber, the nozzles being essentially oppositely directed. Examples of suitable apparatuses are the M 120 E microfluidizer from Microfluidics Corporation and the Expo Nanojet from Nanojet Engineering GmbH.

Another embodiment of the present invention comprises mixing water with at least two more of the components (a), (b), emulsifier, protective colloid, costabilizer and predispersed pigment to form a macroemulsion which is subsequently subjected to ultrasound, for example by means of a Branson Sonifier II 450.

The apparatuses as described in GB-A 2,250,930 and U.S. Pat. No. 5,108,654 for example are suitable for applying ultrasound. The apparatus described in DE 197 56 874 is particularly suitable. Details concerning suitable apparatuses are to be found in WO 02/64657 and the references cited therein.

The embodiments recited above may of course also be combined or carried out repeatedly.

It is preferable to carry out the preparation of the miniemulsion sufficiently quickly for the preparation time to be small compared with the half-life of the reaction of the components (a) with (b) and of (a) with water. The preparation of the miniemulsion is more preferably carried out by cooling to temperatures below room temperature, especially to temperatures between 0° C. and 20° C. To speed the reaction of (a) with (b), the miniemulsion prepared may subsequently be heated after it has been prepared.

According to the present invention, (a) and (b) are mixed with water, pigment and if appropriate one or more surface-active substances and if appropriate further entities and subsequently (a) and (b) are reacted with each other. It is possible in this connection, as well as the aforementioned compounds (b) to add further compounds having isocyanate-reactive groups, for example dithiols, thioethanol, aminoalcohols such as for example ethanolamine, N-methylethanolamine or ethylenediamine to prepare polyurethanes which, as well as urethane groups, additionally bear isocyanurate groups, allophanate groups, urea groups, biuret groups, uretidione groups or carbodiimide groups.

Temperatures in the range from 20 to 120° C., preferably 40 to 105° C. and more preferably 50 to 100° C. may be chosen as a temperature for the reaction of (a) with (b).

The pressure conditions for the reaction of (a) with (b) are generally uncritical in that for example pressures in the range from atmospheric pressure to 10 bar are suitable. To employ temperatures above 100° C., it is advisable to employ elevated pressure.

A time in the range from 30 minutes to 12 hours may be chosen as time for the reaction, preference being given to 2 to 3 hours.

The reaction may be carried out to the accompaniment of mixing, for example by stirring or shaking.

The order of the steps of
addition of components and
employing high shearing forces
   may be carried out in various ways.

One embodiment of the present invention comprises mixing predispersed pigment, (a), (b), emulsifier, if appropriate protective colloid, water and if appropriate costabilizer to form a macroemulsion and subsequently employing strong shearing forces. Thereafter, it is possible for the temperature to be raised and/or catalyst to be added and allowed to react.

Another embodiment of the present invention comprises mixing predispersed pigment, (a), (b), emulsifier and water and if appropriate costabilizer to form a macroemulsion and thereafter employing strong shearing forces, so that a miniemulsion is obtained. This is followed by the addition of further water, further emulsifier, if appropriate protective colloid, if appropriate costabilizer and also further (a). Thereafter it is possible for the temperature to be raised and/or catalyst to be added and allowed to react.

Another embodiment of the present invention comprises mixing predispersed pigment, (a), (b) and if appropriate costabilizer and thereafter adding an aqueous solution of emulsifier and if appropriate protective colloid to form a macroemulsion. Thereafter strong shearing forces are employed, so that a miniemulsion is obtained. This is followed by the addition of predispersed pigment, if appropriate further water and the renewed employment of strong shearing forces. Thereafter it is possible for the temperature to be raised and/or catalyst to be added and allowed to react.

Another embodiment of the present invention comprises mixing predispersed pigment, (a), emulsifier and water to form a macroemulsion and thereafter employing strong shearing forces, so that a miniemulsion is obtained. This is followed by the addition of further water, if appropriate protective colloid, if appropriate costabilizer and also (b) and renewed employment of strong shearing forces. Thereafter it is possible for the temperature to be raised and/or catalyst to be added and allowed to react.

Another embodiment of the present invention comprises mixing predispersed pigment, (b), emulsifier and water to form a macroemulsion. This is followed by the addition of further water, if appropriate protective colloid, if appropriate costabilizer and also (a) and subsequent employment of strong shearing forces. Thereafter it is possible for the temperature to be raised and/or catalyst to be added and allowed to react.

Another embodiment of the present invention comprises mixing predispersed pigment with (a), (b) and a fraction of water to form a macroemulsion and thereafter applying strong shearing forces. This is followed by the addition of further water, emulsifier, if appropriate protective colloid and if appropriate costabilizer. Thereafter it is possible for the temperature to be raised and/or catalyst to be added and allowed to react.

Another embodiment of the present invention comprises mixing (a) and (b) and adding a solution of water and emulsifier and if appropriate protective colloid and costabilizer. A macroemulsion is obtained. This is followed by the addition of pigment predispersed with emulsifier and if appropriate water and renewed mixing. Strong shearing forces are subsequently applied. Thereafter it is possible for the temperature to be raised and/or catalyst to be added and allowed to react.

Another embodiment of the present invention comprises mixing (a), (b), if appropriate costabilizer and if appropriate predispersed pigment. This is followed by the addition of an aqueous solution of emulsifier and optionally if appropriate protective colloid to obtain a macroemulsion. Strong shearing forces are subsequently applied. Thereafter it is possible for the temperature to be raised and/or catalyst to be added and allowed to react.

Another embodiment of the present invention comprises mixing (a), (b) and if appropriate predispersed pigment with tensin. This is followed by the addition of water and if appropriate protective colloid and costabilizer to obtain a macroemulsion. Strong shearing forces are subsequently applied. Thereafter it is possible for the temperature to be raised and/or catalyst to be added and allowed to react.

Another embodiment of the present invention comprises mixing (a), (b), predispersed pigment and if appropriate costabilizer. Thereafter an aqueous solution of emulsifier is added to obtain a macroemulsion. Strong shearing forces are subsequently applied, so that a miniemulsion is obtained. Thereafter it is possible for the temperature to be raised and/or catalyst to be added and allowed to react.

It is possible in principle to add catalyst even before strong shearing forces are applied, preferably in a macroemulsion. This procedure will always be preferable when it is desired to use a catalyst which is liquid at room temperature, for example selected from the above-recited Lewis-acidic organotin compounds.

It is possible in principle to subdivide each of (a) and/or (b) into two portions and to mix in the first portion of (a) and/or (b) before the application of strong shearing forces and to add the second portion of (a) and/or (b) to the miniemulsion which has formed.

It is also possible in principle to substitute pigment which has not been predispersed for predispersed pigment in the embodiments described above.

One embodiment of the present invention comprises adding one or more free-radically polymerizable monomers as a component (c) to carry out the process of the present invention, and in principle all free-radically polymerizable monomers are suitable.

A particularly preferred embodiment comprises adding as a component (c1) a so-called main monomer which comprises at least 40% by weight and preferably at least 60% by weight, based on the total amount of the free-radically polymerizable monomers, in which case the main monomer or monomers is or are selected from C₁-C₂₀-alkyl (meth)acrylates, C₃-C₂₀-cycloalkyl (meth)acrylates, ethylenically unsaturated esters of carboxylic acids which have up to 20 carbon atoms, vinylaromatics having 8 to 20 carbon atoms, (meth)acrylonitrile, vinyl halides such as for example vinyl chloride or vinylidene chloride, unsaturated ethers of C₁-C₁₀-alcohols such as for example vinyl ethers or allyl ethers,

and hydrocarbons having 2 to 24 and preferably 4 to 20 carbon atoms and one or two carbon-carbon double bonds.

Particularly suitable main monomers are for example

(meth)acrylic esters of C₁-C₂₀-alkanols, especially of C₁-C₁₀-alkanols, such as for example methyl acrylate, methyl methacrylate, ethyl acrylate, n-butyl acrylate, 2-ethylhexyl acrylate, ethyl methacrylate, n-butyl methacrylate, 2-ethylhexyl methacrylate and n-decyl acrylate and also mixtures of the aforementioned (meth)acrylates;

(meth)acrylic esters of C₃-C₂₀-cycloalkanols, especially cyclopentyl acrylate, cyclopentyl methacrylate, cyclohexyl acrylate and cyclohexyl methacrylate;

ethylenically unsaturated esters of carboxylic acids which have up to 20 carbon atoms, for example vinyl acetate, vinyl propionate, allyl acetate, allyl propionate, vinyl laurate, vinyl or allyl esters of Versatic® acids such as for example 2,2-dimethylpropionic acid and 2,2-dimethylbutyric acid;

vinylaromatics having 8 to 20 carbon atoms, for example 2-vinyltoluene, 3-vinyltoluene, α-methylstyrene, para-methylstyrene, 4-n-butylstyrene, α-n-butylstyrene, 4-n-decylstyrene and especially styrene, acrylonitrile, methacrylonitrile; vinyl halides such as for example vinyl bromide, chloroprene, vinyl chloride or vinylidene chloride,

unsaturated ethers of C₁-C₁₀-alcohols such as for example vinyl ethers or allyl ethers, for example ethyl vinyl ether, methyl vinyl ether, ethyl-1-allyl ether, vinyl isobutyl ether and vinyl n-decyl ether;

hydrocarbons having 2 to 24 and preferably 4 to 20 carbon atoms and one or two carbon-carbon double bonds, for example ethylene, propene, isobutene, 1-hexadecene, 1-octadecene, α-C₂₀H40, α-C₂₂H44, α-C₂₄H48 and mixtures of the aforementioned olefins, 1,3-butadiene, isoprene.

As well as main monomer, further free-radically polymerizable monomers may be added, for example

C₂-C₁₀-hydroxyalkyl (meth)acrylates such as for example 2-hydroxyethyl (meth)acrylate, 3-hydroxypropyl (meth)acrylate, 4-hydroxybutyl (meth)acrylate, 6-hydroxyhexyl (meth)acrylate; (meth)acrylamide,

C₃-C₂₀-hydroxycycloalkyl (meth)acrylates such as for example cis- and trans-4-hydroxycyclohexyl (meth)acrylate, ethylenically unsaturated carboxylic acids or dicarboxylic acids, for example (meth)acrylic acid, maleic acid, methylenemalonic acid, fumaric acid, itaconic acid, citraconic acid, and

anhydrides of ethylenically unsaturated carboxylic acids and dicarboxylic acids such as for example maleic anhydride, itaconic anhydride and citraconic anhydride.

Very particularly preferred further free-radically polymerizable monomers are C₂-C₁₀-hydroxyalkyl (meth)acrylates.

The free-radical polymerization may be initiated for example by addition of one or more free-radical initiators. Other ways to initiate the free-radical polymerization are illumination, for example by UV/vis radiation.

When a component (c) is to be used, main monomer and if appropriate further monomers and if appropriate free-radical initiator may be added individually or separately at any desired time, for example before or after the action of strong shearing forces.

A specific embodiment of the present invention comprises initially preparing, according to one of the methods described above, a miniemulsion which comprises water, polydispersed pigment, (a), (b), (c), emulsifier, if appropriate costabilizer if appropriate protective colloid. If appropriate free-radical initiator is added while the reaction is allowed to proceed, if appropriate at elevated temperature.

One embodiment comprises adding component (c) and sum total of (a) and (b) in a mass ratio from 1:10 to 10:1.

It is preferable to add one or more free-radicals (initiators) to initiate the addition polymerization of (c), for example thermal initiators or photoinitiators, examples of initiators being organic peroxides or hydroperoxides. As organic peroxides or hydroperoxides there may be mentioned for example di-tert-butyl peroxide, tert-butyl peroctanoate, tert-butyl perpivalate, tert-butylper-2-ethylhexanoate, tert-butyl permaleate, tert-butyl perisobutyrate, benzoyl peroxide, diacetyl peroxide, succinyl peroxide, p-chlorobenzoyl peroxide, dicyclohexyl peroxide dicarbonate. Similarly, the use of redox initiators is suitable, for example for example combinations of hydrogen peroxide or sodium peroxodisulfate or one of the aforementioned peroxides with a reducing agent. Examples of suitable reducing agents are ascorbic acid, tartaric acid, Fe(II) salts such as for example FeSO₄, sodium bisulfite, potassium bisulfite. Suitable initiators are also azo compounds such as 2,2′-azobis(isobutyronitrile), 2,2′-azobis(2-methylpropionamidine) dihydrochloride and 2,2′-azobis(4-methoxy-2,4-dimethylvaleronitrile).

Examples of suitable photoinitiators are to be found for example in P.K.T. Old-Ring, Chemistry and Technology of UV and EB Formulations for Coatings, Inks and Paints, SITA Technology, London 1991, Volume 3, “Photoinitiators for Free Radical and Cationic Polymerisation”.

Preferred photoinitiators are those which decompose on activation through α-cleavage, such as for example photoinitiators of the benzil dialkyl ketal type such as for example benzil dimethyl ketal. Further examples of suitable α-cleavage photoinitiators are derivatives of benzoin, isobutylbenzoin ether, phosphine oxides, especially mono- and bisacylphosphine oxides, for example 2,4,6-trimethylbenzoyidiphenylphosphine oxide, phosphine sulfides and ethyl 4-dimethylaminobenzoate and also

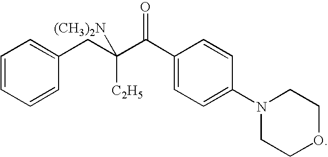

Preferably, at least one photoinitiator is a hydrogen-abstracting photoinitiator for example of the type of the substituted or unsubstituted acetophenones, anthraquinones, thioxanthones, benzoic esters or of the substituted or unsubstituted benzophenones. Particularly preferred examples are isopropylthioxanthone, benzophenone, 4-methylbenzophenone, halomethylated benzophenones, anthrone, Michler's ketone (4,4′-bisdimethylaminobenzophenone), 4-chlorobenzophenone, 4,4′-dichlorobenzophenone, anthraquinone.

One embodiment of the present invention comprises adding from 0.01% to 4% by weight of initiator, based on (c).

After aqueous primary dispersions have been prepared according to the present invention, workup steps may be carried out. For example, filtration steps may be carried out such as for example filtration through one or more filter materials such as for example wovens or nets.

When at least one component (c) has been used, it may be sensible to conduct one or more deodorizing steps, for example by adding more of one or more initiators after the polymerization reaction has died down.

The present invention further provides aqueous primary dispersions obtainable by the process according to the present invention.

Aqueous primary dispersions according to the present invention may have a water content from 30% to 95% by weight and preferably from 50% to 80% by weight.

Aqueous primary dispersions according to the present invention comprise ensheathed pigment in particulate form, and this likewise forms part of the subject matter of the present invention.

Ensheathed pigment according to the present invention may be obtained from aqueous primary dispersion according to the present invention by drying processes. Examples of suitable drying processes are simply evaporation of water and also spray drying and freeze drying.

Ensheathed pigment according to the present invention, which can be prepared by the above-described process according to the present invention, comprise not only pigment but also a sheath which comprises essentially addition polymer, especially polyurethane prepared by miniemulsion polymerization, prepared by reaction of (a) with (b) and if appropriate further components, and if appropriate by free-radical polymerization of further monomers, for example (c).

In one embodiment of the present invention the weight ratio of sheath to pigment is in the range from 1:20 to 20:1, preferably in the range from 1:3 to 3:1 and more preferably in the range from 2:1 to 1:2.

The sheath may have one, two or else actually no measurable glass transition temperature, for example determinable according to ASTM 3418/82. Preferred measurable so-called lower glass transition temperatures can be at least −70° C. and preferably at least −40° C. Preferred so-called upper glass transition temperatures can be up to +120° C. and more preferably +90° C.

The present invention further provides for the use of the present invention's formulations for coating fibrous substrates. The present invention further provides a process for coating fibrous substrates using the present invention's formulations, hereinafter also referred to as inventive coating process, and also coated fibrous substrates obtainable by an inventive coating process.

Fibrous substrates for the purposes of the present invention are in particular leather and textiles or textile substrates, but also paper, paperboard and cardboard.

Leather for the purposes of the present invention is to be understood as meaning pretanned, tanned and if appropriate retanned leather or correspondingly processed synthetic replacement material, which may each have already been treated with at least one dye during at least one tanning step. Leather in the realm of the present invention has preferably been hydrophobicized and/or fatliquored.

Inventive aqueous primary dispersions are compatible with commercially available assistants for finishing leather to regulate hand, color, flow and viscosity. These are generally solutions (for example flow assistants, products based on glycol ethers, ethers, such as for example butylglycol, methoxypropanol, tributoxyethyl phosphate) or emulsions/dispersions with casein, waxes, silicones in the customary use quantities or concentrations (see F. Stather, Gerbereichemie u. Gerbereitechnologie, Akademie Verlag Berlin, 1967, 507-632).

Textiles and textile substrates for the purposes of the present invention are textile fibers, textile intermediate and end products and finished articles manufactured therefrom which, as well as textiles for the apparel industry, also comprise for example carpets and other home textiles and also textile structures for industrial purposes. These also include unshaped structures such as for example staples, linear structures such as twine, filaments, yarns, lines, strings, laces, braids, cordage, threads and also three-dimensional structures such as for example felts, wovens, nonwovens and waddings. Textiles can be of natural origin, for example cotton, wool or flax, or synthetic, for example polyamide, polyester, modified polyester, polyester blend fabric, polyamide blend fabric, polyacrylonitrile, triacetate, acetate, polycarbonate, polypropylene, polyvinyl chloride, polyester microfibers and glass fiber fabric.

In a specific embodiment of the present invention, the inventive coating of textile substrates is an inventive process for textile printing.

In a specific embodiment of the present invention, the inventive coating process is a process for finishing leather. The purpose of finishing/coating leather is to endow leather with the desired appearance, specific haptic properties and also service fastnesses, such as for example flex elasticity, wet and dry rub fastness, perspiration resistance and water fastness.

It is possible to apply a bottoming dispersion consisting of customary constituents. In one embodiment, the inventive coating process proceeds from pretanned, tanned and if appropriate retanned leather which may have already been hydrophobicized and dyed in a conventional manner.

The initial step is to apply at least one bottoming dispersion, comprising one or more inventive aqueous primary dispersions in such an amount to the leather to be colored that about 10 to 100 g of solids are applied per m² of leather surface area. Application may be accomplished by conventional methods, for example by plushing, i.e., application with sponge or brushlike apparatus which may be covered with plush or velvet fabric, by brushing, roll coating, casting, spraying or atomizing. The leather thus treated may subsequently be dried, for example at a temperature in the range from 30 to 120° C., preferably 60 to 80° C. The application of at least one bottoming dispersion may take place in one or more steps, which may be carried out identically or differently and may each be interrupted by an intervening drying at the abovementioned temperatures.

In a preferred embodiment of the present invention, a bottoming dispersion used according to the present invention comprises at least one inventive aqueous primary dispersion.

Bottoming dispersions used according to the present invention, hereinafter also referred to as inventive bottoming dispersions, are typically aqueous. They may comprise further, nonaqueous solvents such as for example ethylene glycol, N-methylpyrrolidone, 3-methoxypropanol and propylene carbonate. In a preferred embodiment, inventive bottoming dispersions comprise the following constituents:
α1) at least one inventive aqueous primary dispersion, preferably 20 to 70% by weight, based on the total weight of inventive bottoming dispersion;
β1) optionally at least one wax, such as for example oxidized polyethylene wax or montan wax, preferably 1 to 15% by weight based on the total weight of inventive bottoming dispersion;
χ1) optionally at least one biocide, for example 1,2-benzisothiazolin-3-one (“BIT”) (commercially available as Proxel® from Avecia Lim.) and its alkali metal salts; other suitable biocides are 2-methyl-2H-isothiazole-3 (“MIT”) and 5-chloro-2-methyl-2H-isothiazol-3-one (“CIT”). In general, 10 to 150 ppm of biocide based on bottoming dispersion are sufficient.
β1) optionally at least one pigment in particulate form,
ε1) optionally at least one further binder.

Inventive bottoming dispersions may further comprise at least one filling and antiadhesive agent. Suitable are for example aqueous formulations of fatty acid ester, albumen and inorganic filler which may be selected from silicates and clay minerals.

Inventive bottoming dispersions may have a solids content of 10 to 80% by weight, preference being given to 20 to 50% by weight.

A pigment coat may subsequently be applied in a conventional manner. The pigment coat may consist of customary constituents.

In one embodiment of the present invention, the pigment coat comprises
α2) at least one inventive aqueous primary dispersion, preferably 20 to 70% by weight, based on the total weight of inventive pigment coat,
β2) at least one wax, such as for example oxidized polyethylene wax or montan wax or silicone wax, preferably 1 to 15% by weight, based on the total weight of inventive pigment coat;
γ2) optionally at least one biocide, for example selected from MIT, BIT and CIT, for example in the amounts mentioned for bottoming dispersions,
δ2) optionally at least one pigment in particulate form,
ε2) optionally at least one thickener.

Seasoning may subsequently be applied in the form of a seasoning dispersion, at about 5 to 30 g/m² of leather surface area. The seasoning top coat serves to protect the leather and shall ensure not only high flexibility but also good scratch resistance, oil resistance and water resistance. Depending on the desired article, the seasoning top coat shall be lustrous or matte, i.e., matting agents or delusterants may also be added. Seasonings may comprise for example: formulations composed of at least one binder based on acrylate or polyurethane, a wetting agent, albumen, nitrocellulose emulsion, fillers based on organic or inorganic delusterants, silicone wax, fatty acid ester.

Inventive seasoning dispersions may comprise known polyurethane dispersions prepared according to EP-A2 0 392 352.

Pigment coats and seasoning dispersions may comprise one or more thickeners. Examples are crosslinkable copolymers based on acrylic acid and acrylamide and also thickeners based on polyurethane or polyvinylpyrrolidone or acrylate (co)polymers.

Application of the seasoning may be followed by drying under customary conditions, for example at temperatures in the range from 60 to 80° C., and subsequent hot pressing, for example at temperatures in the range from 140 to 180° C. It is also possible to hot press hydraulically, for example at reduced pressure and temperatures in the range from 70 to 100° C. Conventional apparatuses for ironing are contemplated, such as for example ironing presses or continuous pressing machines.

The inventive process for finishing leather utilizes at least one inventive aqueous primary dispersion in at least one step—bottoming, pigment coating and seasoning.

A further embodiment of the present invention is a process for preparing printed textile using at least one inventive aqueous primary dispersion, hereinafter also referred to as inventive textile printing process.

The inventive textile printing process may be carried out for example by incorporating at least one inventive aqueous primary dispersion in a print paste, hereinafter also referred to as inventive print paste, and thereafter printing textile substrates in a conventional manner.

Advantageously, the inventive print paste for textile printing is prepared by mixing at least one inventive aqueous primary dispersion with customary printing assistants. The depth of shade is customarily set by adjusting the ratio of pigment to binder.

Customary assistants are known from Ullmann, Handbuch der technischen Chemie and Verfahrenstechnik, compare for example Ullmann's Enyclopedia of Industrial Chemistry, 5th edition, headword: Textile Auxiliaries, volume A26, pages 286 ff. and 296 ff., Verlag Chemie, Weinheim, Deerfield/Florida, Basle; 1996. Examples of customary assistants used are thickeners, fixatives, hand improvers and emulsifiers:

Thickeners used may be natural or synthetic thickeners. Preference is given to the use of synthetic thickeners, for example of generally liquid solutions of synthetic (co)polymers in for example white oil or as aqueous solutions or as water-in-oil emulsions, preferably with about 40% by weight of (co)polymer.

Preferred examples of thickeners are copolymers with 85 to 95% by weight of acrylic acid, 4 to 14% by weight of acrylamide and about 1% by weight of the (meth)acrylamide derivative of the formula II 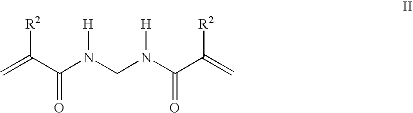
having molecular weights M_{w} in the range from 100 000 to 200 000 g/mol, in each of which the R³ radicals may be the same or different and may represent methyl or hydrogen.

Inventive print pastes may comprise 30 to 70% by weight of white oil. Aqueous thickeners comprise typically up to 25% by weight of (co)polymer, in some cases up to 50% by weight (so-called thickener dispersions). When it is desired to use aqueous formulations of a thickener, aqueous ammonia is generally added. Even the use of granular, solid formulations of a thickener are conceivable in order to be able to produce pigment prints emissionlessly.

Inventive print pastes may further comprise hand improvers, which are customarily selected from silicones, especially polydimethylsiloxanes, and fatty acid esters. Examples of commercially available hand improvers which can be added to the inventive print pastes are Acramin® Weichmacher SI (Bayer AG), Luprimol SIG® and Luprimol CW® (BASF Aktiengesellschaft).

Inventive print pastes may include as further ingredients one or more emulsifiers, especially when the pastes contain white oil-containing thickeners and are obtained as oil-in-water emulsion. Examples of suitable emulsifiers are aryl- or alkyl-substituted polyglycol ethers. Commercially available examples of suitable emulsifiers are Emulgator W® (Bayer), Luprintol PE New® and Luprintol MP® (BASF Aktiengesellschaft), and Solegal W® (Hoechst AG).

Further ingredients include Bronsted acids such as for example ammonium hydrogenphosphate, preferably no Bronsted acid is added.

Pigment printing using at least one inventive print paste may be carried out according to various processes known per se. It is customary to use a screen through which the inventive print paste is forced with a squeegee. This process belongs to the screen printing processes. Inventive pigment printing processes using at least one inventive print paste provide printed substrates combining particularly high brilliance and depth of shade for the prints with excellent hand for the printed substrates. The present invention accordingly also provides substrates printed by the inventive printing process using the inventive print pastes.

The present invention further provides coated fibrous substrates obtainable by the inventive coating process using at least one inventive aqueous primary dispersion. Coated fibrous substrates according to the present invention are notable for example for good wet rub fastnesses and can be prepared even in deep shades at a very good crosslinking (quantum) yield for photoinitiators.

The present invention further provides for the use of inventive aqueous primary dispersions as or for producing inks for the ink jet process. The present invention further provides a process for producing inks for the ink jet process using inventive aqueous primary dispersions. The present invention further provides inks for the ink jet process which consist of or contain at least one aqueous primary dispersion of the present invention.

Ink jet process inks in accordance with the present invention are particularly easy to produce by at least one aqueous primary dispersion which is in accordance with the present invention being diluted with, for example, water and if appropriate admixed with additives.

In a preferred embodiment of the present invention, an inventive ink for the ink jet process contains from 1 to 50 g/100 ml, and preferably from 1.5 to 15 g/100 ml of pigment.

Additives for inclusion in inventive inks for the ink jet process include organic solvents. Low molecular weight polytetrahydrofuran is a preferred additive, it may be used alone or preferably mixed with one or more high-boiling water-soluble or water-miscible organic solvents.

The preferably used low molecular weight polytetrahydrofuran customarily has an average molecular weight M_{w} from 150 to 500 g/mol, preferably from 200 to 300 g/mol and more preferably of about 250 g/mol (as corresponds to a molecular weight distribution).

Polytetrahydrofuran is preparable in a known manner via cationic polymerization of tetrahydrofuran. The products are linear polytetramethylene glycols.

When polytetrahydrofuran mixed with further organic solvents is used as an additive, the solvents used for this purpose are generally high boiling (i.e., generally have a boiling point >100° C. at atmospheric pressure) and hence water-retaining organic solvents which are soluble in or miscible with water.

Useful solvents include polyhydric alcohols, preferably unbranched and branched polyhydric alcohols having from 2 to 8 and especially from 3 to 6 carbon atoms, such as ethylene glycol, 1,2-propylene glycol, 1,3-propylene glycol, glycerol, erythritol, pentaerythritol, pentitols such as arabitol, adonitol and xylitol and hexitols such as sorbitol, mannitol and dulcitol.

Useful solvents further include polyethylene glycols and polypropylene glycols (which is also to be understood as meaning the lower polymers (di-, tri- and tetramers)) and their mono (especially C₁-C₆, in particular C₁-C₄) alkyl ethers. Preference is given to polyethylene and polypropylene glycols having average molecular weights of from 100 to 1500 g/mol, in particular from 200 to 800 g/mol, mainly from 300 to 500 g/mol. Examples are diethylene glycol, triethylene glycol, tetraethylene glycol, diethylene glycol monomethyl ether, diethylene glycol monoethyl ether, diethylene glycol monopropyl ether, diethylene glycol monobutyl ether, triethylene glycol monomethyl ether, triethylene glycol monoethyl ether, triethylene glycol monopropyl ether, triethylene glycol monobutyl ether, di-, tri- and tetra-1,2- and -1,3-propylene glycol and di-, tri- and tetra-1,2- and -1,3-propylene glycol monomethyl, monoethyl, monopropyl and monobutyl ether.

Useful solvents further include pyrrolidone and N-alkylpyrrolidones whose alkyl chain preferably comprises from 1 to 4, especially 1 or 2, carbon atoms. Examples of useful alkylpyrrolidones are N-methylpyrrolidone, N-ethylpyrrolidone and N-(2-hydroxyethyl)-pyrrolidone.

Examples of particularly preferred solvents are 1,2-propylene glycol, 1,3-propylene glycol, glycerol, sorbitol, diethylene glycol, polyethylene glycol (M, from 300 to 500 g/mol), diethylene glycol monobutyl ether, triethylene glycol monobutyl ether, pyrrolidone, N-methylpyrrolidone and N-(2-hydroxyethyl)pyrrolidone.

Polytetrahydrofuran may also be mixed with one or more (e.g., two, three or four) of the abovementioned solvents.

In one embodiment of the present invention, the inventive inks for the ink jet process may comprise from 0.1 to 80% by weight, preferably from 5% to 60% by weight, more preferably from 10% to 50% by weight and most preferably from 10% to 30% by weight of nonaqueous solvents.

Nonaqueous solvent additives, including especially the particularly preferred solvent combinations mentioned, may advantageously be augmented with urea (generally from 0.5% to 3% by weight, based on the weight of the colorant preparation) to further enhance the water-retaining effect of the solvent mixture.

The inventive inks for the ink jet process may comprise further assistants of the type which are customary especially for aqueous ink jet inks and in the printing and coatings industry. Examples of such assistants are preservatives such as for example 1,2-benzisothiazolin-3-one (commercially available as Proxel brands from Avecia Lim.) and its alkali metal salts, glutaraldehyde and/or tetramethylolacetylenediurea, Protectols®, antioxidants, degasers/defoamers such as for example acetylenediols and ethoxylated acetylenediols, which customarily comprise from 20 to 40 mol of ethylene oxide per mole of acetylenediol and also may have a dispersing effect, agents for regulating the viscosity, flow assistants, wetting agents (for example wetting surfactants based on ethoxylated or propoxylated fatty or oxo alcohols, propylene oxide-ethylene oxide block copolymers, ethoxylates of oleic acid or alkylphenols, alkylphenol ether sulfates, alkylpolyglycosides, alkyl phosphonates, alkylphenyl phosphonates, alkyl phosphates, alkylphenyl phosphates or preferably polyethersiloxane copolymers, especially alkoxylated 2-(3-hydroxypropyl)heptamethyltrisiloxanes, which generally have a block of 7 to 20 and preferably 7 to 12 ethylene oxide units and a block of 2 to 20 and preferably 2 to 10 propylene oxide units and may be included in the colorant preparations in amounts from 0.05% to 1% by weight), antisettling agents, luster improvers, lubricants, adhesion promoters, antiskinning agents, delusterants, emulsifiers, stabilizers, hydrophobicizers, light control additives, hand improvers, antistats, bases such as for example triethanolamine or acids, specifically carboxylic acids such as for example lactic acid or citric acid for regulating the pH. When these agents are part of inventive inks for the ink jet process, their total amount will generally be 2% by weight and especially 1% by weight, based on the weight of the inventive colorant preparations and especially of the inventive inks for the ink jet process.

In one embodiment of the present invention, the inventive inks for the ink jet process have a dynamic viscosity in the range from 2 to 80 mPa·s and preferably in the range from 3 to 20 mPa·s, measured at 23° C.

The surface tension of inventive inks for the ink jet process is generally in the range from 24 to 70 mN/m and especially in the range from 25 to 60 mN/m, measured at 25° C.

The pH of inventive inks for the ink jet process is generally in the range from 5 to 10 and preferably in the range from 7 to 9.

A further aspect of the present invention is a process for printing sheetlike or three-dimensional substrates by the ink jet process using the ink jet process inks of the present invention. To this end, at least one ink jet inks which are in accordance with the present invention is printed onto the substrate and the print obtained is optionally subsequently fixed.

In the ink jet process, the typically aqueous inks are sprayed as small droplets directly onto the substrate. There is a continuous form of the process, in which the ink is pressed at a uniform rate through a nozzle and the jet is directed onto the substrate by an electric field depending on the pattern to be printed, and there is an interrupted or drop-on-demand process, in which the ink is expelled only where a colored dot is to appear, the latter form of the process employing either a piezoelectric crystal or a heated hollow needle (bubble or thermal jet process) to exert pressure on the ink system and so eject an ink droplet. These techniques are described in Text. Chem. Color 19 (1987), No. 8, 23-29, and 21 (1989), No. 6, 27-32.

The inventive inks are particularly suitable for the bubble jet process and for the process employing a piezoelectric crystal.

Suitable Substrate Materials are:

cellulosic materials such as paper, paperboard, cardboard, wood and woodbase, which may each be lacquered or otherwise coated, metallic materials such as foils, sheets or workpieces composed of aluminum, iron, copper, silver, gold, zinc or alloys thereof, which may each be lacquered or otherwise coated,

silicatic materials such as glass, porcelain and ceramic, which may each be coated,

polymeric materials of any kind such as polystyrene, polyamides, polyester, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers including block copolymers, biodegradable polymers and natural polymers such as gelatin,

leather—both natural and artificial—in the form of smooth leather, nappa leather or suede leather,

comestibles and cosmetics,

and especially

textile substrates such as fibers, yarns, threads, knits, wovens, nonwovens and made-up goods composed of polyester, modified polyester, polyester blend fabric, cellulosic materials such as cotton, cotton blend fabric, jute, flax, hemp and ramie, viscose, wool, silk, polyamide, polyamide blend fabric, polyacrylonitrile, triacetate, acetate, polycarbonate, polypropylene, polyvinyl chloride, polyester microfibers and glass fiber fabric.

Ink jet process inks in accordance with the present invention have altogether advantageous performance properties, especially good start-of-print behavior and good sustained-use behavior (kogation) and also, especially if the particularly preferred solvent combination is used, good drying behavior, and produce printed images of high quality, i.e., high brilliance and depth of shade and also high rub, light, water and wet rub fastness. They are particularly useful for printing coated and plain paper and also textiles.

The present invention further provides substrates, especially textile substrates, which have been printed by one of the abovementioned processes according to the present invention and are notable for particularly crisply printed images or drawings and also excellent hand.

In a further embodiment of the present invention at least two and preferably at least three different ink jet process inks according to the present invention may be combined to form sets, wherein different inks according to the present invention each comprise different pigments each comprising a different color. The invention is illustrated by working examples.

General Preliminary Remarks:

Strong shearing forces are in each case introduced by sonication. Sonication as used hereinbelow shall be understood as referring in each case to sonication with a Branson Sonifier W 450 ultrasonicator at 100% amplitude and 50% pulse.

The particle size distribution of the pigment particles treated according to the present invention was determined in accordance with ISO 13321 using a 2C Autosizer from Malvern. The number average particle diameter is reported in each case.

The pigment used at all times was a carbon black having the following properties: number average primary particle diameter 16 nm, determined by electron microscopy, hereinafter referred to as carbon black for short. BET surface area: 343 m²/g measured by nitrogen adsorption. Such a carbon black is commercially available as Cabot Monarchs 1000.

I. Preparation of Inventive Aqueous Primary Dispersions

### EXAMPLE 1

Preparation of Miniemulsion 1:

A stirred beaker was used to mix 3 g of polytetrahydrofuran having an M, molecular weight of 1000 g/mol with 0.3 g of ethylene glycol and 2.0 g of isophorone diisocyanate (IPDI) at 20° C. A mixture of 1.4 g of 15% by weight aqueous solution of sodium dodecyl sulfate and 30.4 g of completely ion-free water was added and thoroughly stirred in for one minute at 200 rpm. The macroemulsion obtained was then cooled to about 0° C. with an ice bath and sonicated for 90 seconds with ice cooling to provide miniemulsion 1.

Preparation of Primary Dispersion 1:

4 g of carbon black were stirred with 4.4 g of a 15% by weight aqueous solution of sodium dodecyl sulfate and 22.7 g of completely ion-free water at 20° C. for one hour. This was followed by cooling to 0° C. with an ice bath and a 2 minute sonication with ice cooling to obtain predispersed pigment 1.

Miniemulsion 1 and predispersed pigment 1 were mixed in a beaker and sonicated for 120 seconds with ice cooling.

This was followed by the addition of 2 drops of dibutyltin dilaurate (DBTL), removal of the ice bath and heating to 60° C. for 4 hours. The mixture was filtered through nets having a pore size of 125 μm, 40 μm and 5 μm to obtain an inventive aqueous primary dispersion 1 having a solids content of 10% by weight (water content: 90% by weight). Average particle diameter: 101 nm.

### EXAMPLE 2

Preparation of Miniemulsion 2:

A stirred beaker was used to mix 2.5 g of polytetrahydrofuran having an Mₙ of 1000 g/mol with 0.34 g of 1,4-butanediol, 0.11 g of trimethylolpropane, 0.12 g of n-hexadecane and 1.67 g of isophorone diisocyanate (IPDI) at 20° C. A mixture of 1.2 g of 15% by weight aqueous solution of sodium dodecyl sulfate and 26.8 g of completely ion-free water was added and thoroughly stirred in for one minute at 200 rpm. The macroemulsion obtained was then cooled to 0° C. with an ice bath and sonicated for 90 seconds to provide miniemulsion 2.

Preparation of Primary Dispersion 2:

4 g of carbon black were stirred with 4.4 g of a 15% by weight aqueous solution of sodium dodecyl sulfate and 22.7 g of completely ion-free water at 20° C. for one hour. This was followed by cooling to 0° C. with an ice bath and a 2 minute sonication with ice cooling to obtain predispersed pigment 2.

Miniemulsion 2 and predispersed pigment 2 were mixed in a beaker and sonicated for 120 seconds with ice cooling.

This was followed by the addition of 2 drops of dibutyltin dilaurate (DBTL), removal of the ice bath and heating to 60° C. for 4 hours. The mixture was filtered through nets having a pore size of 125 μm, 40 μm and 5 μm to obtain an inventive aqueous primary dispersion 2 having a solids content of 6.2% by weight (water content: 93.8% by weight). Average particle diameter: 104 nm.

### EXAMPLE 3

Preparation of Miniemulsion 3:

A stirred beaker was used to mix 1.6 g of polytetrahydrofuran having an Mₙ of 1000 g/mol with 1.03 g of 2,2-butylethylpropane-1,3-diol and 2.13 g of isophorone diisocyanate (IPDI) at 20° C. A mixture of 0.3 g of 28% by weight solution of a C₁₂-alkylpolyethoxy sulfate having an average degree of ethoxylation of 2.5 and 27.3 g of completely ion-free water was added and thoroughly stirred in for one minute. The macroemulsion obtained was then cooled to 0° C. with an ice bath and sonicated for 90 seconds with ice cooling to provide miniemulsion 3.

Preparation of Primary Dispersion 3:

4 g of carbon black were stirred with 4.4 g of a 15% by weight aqueous solution of sodium dodecyl sulfate and 22.7 g of completely ion-free water at 20° C. for one hour. This was followed by cooling to 0° C. with an ice bath and a 2 minute sonication with ice cooling to obtain predispersed pigment 3.

Miniemulsion 3 and predispersed pigment 3 were mixed in a beaker and sonicated again for 120 seconds with ice cooling.

This was followed by the addition of 2 drops of dibutyltin dilaurate (DBTL), removal of the ice bath and heating to 60° C. for 4 hours. The mixture was filtered through nets having a pore size of 125 μm, 40 μm and 5 μm to obtain an inventive aqueous primary dispersion 3 having a solids content of 5.7% by weight (water content: 94.3% by weight). Average particle diameter: 86 nm.

### EXAMPLE 4

Preparation of Miniemulsion 4:

A stirred beaker was used to mix 2.7 g of a polyesterdiol formed from adipic acid and 1,4-butanediol (OH number: 141, determined in accordance with DIN 53240) with 0.61 g of 1,4-butanediol, 0.14 g of n-hexadecane and 2.26 g of isophorone diisocyanate (IPDI) at 20° C. A mixture of 1.5 g of 15% by weight aqueous solution of sodium dodecyl sulfate and 25.1 g of completely ion-free water was added and thoroughly stirred in for one minute at 200 rpm. The macroemulsion obtained was then cooled to 0° C. with an ice bath and sonicated for 60 seconds with ice cooling to provide miniemulsion 4.

Preparation of Primary Dispersion 4:

4 g of carbon black were stirred with 4.4 g of a 15% strength solution of sodium dodecyl sulfate and 22.7 g of completely ion-free water at 20° C. for one hour. This was followed by cooling to 0° C. with an ice bath and a 2 minute sonication with ice cooling to obtain predispersed pigment 4.

Miniemulsion 4 and predispersed pigment 4 were mixed and sonicated for 3 minutes with ice cooling.

This was followed by the addition of 2 drops of dibutyltin dilaurate (DBTL), removal of the ice bath and heating to 60° C. for 5 hours. The mixture was filtered through nets having a pore size of 125 μm, 40 μm and 5 μm to obtain an inventive aqueous primary dispersion 4 having a solids content of 10% by weight (water content: 90% by weight). Average particle diameter: 127 nm.

II. Illustrative Use

2.1. Formulation of an Ink for the Ink Jet Process

The following ingredients were mixed with each other in a beaker by stirring:
1 g of urea,
3 g of triethylene glycol mono-n-butyl ether,
7 g of polyethylene glycol with Mₙ=400 g/mol,
8 g of glycerol,
0.5 g of a 20% by weight solution of benzisothiazolin-3-one in propylene glycol,
0.1 g of ethoxylated trisiloxane of the formula [(CH₃)₃Si—O]₂—Si(CH₃)—O(CH₂CH₂O)₈—H
53 g of completely ion-free water.
25 g of inventive primary dispersion 4 were added to obtain the inventive ink 11.4 for the ink jet process.

Printing Test with Inventive Ink II.4 for the Ink Jet Process:

The inventive ink was printed onto paper using an Epson 3000 720 dpi printer. 5 A4 pages were obtained without nozzle blockage. Good values were obtained in the rub fastness tests.

1. A process for producing aqueous primary dispersions of polymer-ensheathed pigment, which comprises
(a) at least one polyfunctional isocyanate and
(b) at least one compound having isocyanate-reactive groups selected from polyetherols, polyesterols, polyhydric alcohols having up to 8 carbon atoms, polycarbonate diols, polyhydroxyolefins, polyhydroxyurethanes, polyisobutenediols, polysiloxanes having on average at least 2 hydroxyl groups per molecule and lactone-based polyesterdiols
being mixed with pigment, water and if appropriate one or more surface-active substances and reacted with each other.

2. The process according to claim 1 wherein (a) and (b) are mixed with water and pigment to form a miniemulsion having an average diameter in the range from 20 to 1000 nm for the monomer droplets.

3. The process according to claim 1 wherein at least one pigment is an organic pigment or is carbon black.

4. The process according to claim 1 that utilizes pigment in predispersed form.

5. The process according to claim 4 that utilizes a compound (a) or (b) as a surface-active substance.

6. The process according to claim 1 wherein one or more free-radically polymerizable monomers are added as a component (c).

7. An aqueous primary dispersion produced by a process according to claim 1.

8. The aqueous primary dispersion according to claim 6 wherein the water content is in the range from 30% to 95% by weight.

9. Use of The method of using aqueous primary dispersions according to claim 6 for finishing leather.

10. Leather finished using at least one aqueous primary dispersion according to claim 6.

11. Use of The method of using aqueous primary dispersions according to claim 7 in textile printing.

12. A textile colored using at least one aqueous primary dispersion according to claim 6.

13. A print paste comprising at least one aqueous primary dispersion according to claim 7.

14. A fibrous substrate ensheathed using at least one aqueous primary dispersion according to claim 7.

15. The method of using aqueous primary dispersions according to claim 6 as or for producing inks for the ink jet process.

16. An ink jet process ink comprising at least one aqueous primary dispersion according to claim 6.

17. An ensheathed pigment obtainable by a process according to claim 1 and subsequent application of a drying process.

18. A process for producing ensheathed pigments, which comprises first producing an aqueous primary dispersion according to claim 1 and then isolating the ensheathed pigment by a drying process.
